(19) United States
(12) Patent Application Publication
(10) Pub. No.: US 2014/0092376 A1
(43) Pub. Date: Apr. 3, 2014

(54) CONTAINER AND METHOD FOR IN-LINE ANALYSIS OF PROTEIN COMPOSITIONS

(71) Applicant: MOMENTIVE PERFORMANCE MATERIALS, INC, Albany, NY (US)

(72) Inventors: Guangjun XU, San Jose, CA (US); Robert Koch, Shaker Heights, OH (US); Madhuri Raju, Bangalore (IN); Simon Williams, Voorhees, NJ (US)

(73) Assignee: MOMENTIVE PERFORMANCE MATERIALS, INC., Albany, NY (US)

(21) Appl. No.: 13/632,319

(22) Filed: Oct. 1, 2012

(51) Int. Cl. G01N 21/01; G01N 21/59; G01J 3/44; G01N 21/17; G01J 3/28; G01J 4/00

(52) U.S. Cl. 356/51; 356/246; 356/364; 356/301; 356/73; 356/440

(57) ABSTRACT

A system and method for the in-line analysis of protein-containing compositions for protein denaturation. The system and method employ providing a protein-containing composition in a container that can be directly used in an analytical method for evaluating the denaturation of a protein. The container can be directly employed in an analytical technique such as UV spectroscopy, circular dichroism, etc.

### FIELD

The present invention provides a container for housing biological macromolecule-containing compositions, e.g., medicinal or pharmaceutical compositions, and a method for analyzing such compositions. In particular, the present invention provides a system and method for the in-line analysis of biological macromolecule-containing compositions.

### BACKGROUND

Biological macromolecule formulations, e.g., protein formulations, can be used in a variety of applications including, for example, pharmaceutical and biomedical applications. Proteins, for example, can have therapeutic efficacy useful for treating certain conditions, diseases, etc. Proteins have highly ordered, three-dimensional structures, and a protein's activity, efficacy, and functionality depend on the protein's three-dimensional structure. A change in the structure of the molecule, which is referred to as denaturation, can alter the secondary, tertiary, or quaternary structure of the molecule, which can reduce or destroy the molecule's activity and functionality.

Protein denaturation, for example, can result from various physical and chemical changes to the protein composition including, but not limited to, changes in temperature, pH, dielectric constant, ionic strength, etc. Protein compositions such as pharmaceutical and medicinal compositions can be exposed to extreme conditions or temperature fluctuations during shipping or storage that could affect the structural integrity of the protein (e.g., cause the protein to denature).

Researchers have sought to produce highly stable protein compositions, but protein compositions must generally be analyzed for quality control purposes to determine whether the material has undergone denaturation and is suitable for use in treatment. Proteins can be evaluated by a number of techniques including, for example, ultraviolet (UV) spectroscopy. The state of the protein in the solution is evaluated by determining the LTV absorption of the solution.

Current methods for sampling and evaluating pharmaceutical compositions require invasive techniques. Specifically, testing the samples requires removing at least a portion of the solution from the container, e.g., a vial, ampoule, etc., housing the solution. This generally requires opening the container, which may expose the solution to environmental conditions and potential contamination and may require destruction of the container. Thus, solutions that are tested may not be suitable for further use and have to be discarded. This limits the testing that can be performed and allows for only random sampling of a lot of material. Consequently, testing can be time consuming and expensive in terms of both man hours to conduct the testing, potential loss of material, and the inability to ensure the quality of all samples (i.e., the inability to achieve 100% quality control).

### SUMMARY

The present invention provides a system and method for in-line analysis of biological macromolecule-containing compositions. In one embodiment, the present invention provides a container for storing biological macromolecule-containing compositions, where the container can be used in a testing method for evaluating the state of the biological macromolecule.

In one embodiment, the present invention provides a method for evaluating the state of a biological macromolecule comprising providing a container comprising a biological macromolecule-containing composition, and subjecting the container to a detection method for evaluating a property of the composition that relates to a property of the biological macromolecule in the composition.

In one embodiment, the container comprising the biological macromolecule-containing composition is formed of high purity quartz glass. In one embodiment, the quartz glass composition has a silica content of about 99 wt. % or greater; 99.9 wt. % or greater; 99.99 wt. % or greater; even 99.999 wt. % or greater. In one embodiment the container is formed from fused quartz.

In one embodiment, the detection method for evaluating the structural integrity of the biological macromolecule comprises ultraviolet spectroscopy.

The system and method provide a container and detection method that allow for the in-line, non-destructive analysis of biological macromolecule-containing samples. In particular, the containers can be used directly in analytical techniques, such as UV spectroscopy, that are suitable for protein degradation, etc. The method and system avoids and can eliminate the need to remove a sample of a biological macromolecule-containing composition from its packaging, which can result in destruction of the package or contamination of the sample. Thus, in one aspect, the present invention allows for the possibility of inspecting or analyzing 100% of the composition in a lot of biological macromolecule-containing products.

These and other aspects of the invention can be further understood with respect to the following detailed description.

### BRIEF DESCRIPTION OF THE DRAWINGS

FIGS. 1a-e are schematic representations of container shapes in accordance with aspects of the invention; and

FIG. 2 is a graph showing the LTV transmittance of glass composition in accordance with aspects of the invention compared to a borosilicate glass.

### DETAILED DESCRIPTION

A system and method of analyzing biological macromolecule-containing compositions comprises providing a container comprising a biological macromolecule-containing composition, subjecting the container to an analytical method and evaluating a property of the composition corresponding to a property of the biological macromolecule in the biological macromolecule-containing composition that relates to or is indicative of a property of the biological macromolecule of the composition.

Biological macromolecule-containing compositions are provided in a container that can be directly used in an analytical method for evaluating or analyzing a property of the biological macromolecule. In one embodiment, the biological macromolecule-containing composition is provided in a container formed from a quartz glass composition.

The containers or packaging for housing the biological macromolecule-containing compositions are formed from quartz glass compositions comprising silica (SiO₂). The silica (SiO₂) used in the glass compositions of the present embodiments can be made from synthetic sand, natural sand, or a mixture thereof. In one embodiment, the amount of SiO₂ in the glass composition ranges from about 82 to about 99.9999%. In another embodiment, the amount of SiO₂ in the glass composition ranges from about 92 to about 99.9999%; from about 96 to about 99.9999 wt. %; from about 97 to about 99.9999 wt. %; even from about 98 to about 99.9999 wt. %. In another embodiment, the glass comprises a light-transmissive, vitreous composition with a SiO₂ content of at least about 90 wt. %. In still another embodiment of a quartz composition with a high melting point, at least 95 wt. % SiO₂ is used. In yet another embodiment, the glass composition has a SiO₂ concentration of at least about 97 wt. %; at least about 98 wt. %; even at least about 99 wt. %. In still other embodiments, the glass composition for forming the container has a silica content of about 99 wt. % or greater: about 99.9 wt. % or greater; about 99.99 wt. % or greater; about 99.999 wt. % even about 99.9999 wt. % or greater. Here as elsewhere in the specification and claims, ranges can be combined to form new and non-disclosed ranges. It will be appreciated that the formed glass products, e.g., the containers as packaging will have a SiO₂ content the same or substantially similar to that of the glass composition used to form such glass product.

Depending on the desired properties of the packaging container, a number of different dopants and mixtures thereof can be added to the silica. The dopants and concentration of such dopants should be selected such that the article formed from the composition exhibits suitable properties for use in an analytical technique to evaluate the concentration or other property of a biological macromolecule-containing composition. In one embodiment the glass composition can be selected to provide a glass article that exhibits low leaching of cations into the biological macromolecule-containing composition.

Particularly suitable dopants are those that exhibit low solubility in the various (aqueous-based) biological macromolecule-containing compositions that are to be stored in the containers. Examples of suitable dopants include Al₂O₃, GeO₂, Ga₂O₃, CeO₂, ZrO₂, TiO₂, Y₂O₃, La₂O₃, Nd₂O₃, other rare earth oxides, and mixtures of two or more thereof. In one embodiment, the dopant is neodymium oxide Nd₂O₃. In another embodiment, the dopant is aluminum oxide by itself, e.g., Al₂O₃, or a mixture of aluminum oxide and other dopants. In another embodiment, the dopant is CeO₂. In yet another embodiment, titanium oxide (TiO₂) can be added. In another embodiment, the dopant comprises europium oxide, Eu₂O₃, by itself, or in combination with other dopants such as TiO₂ and CeO₂. In still another embodiment, the dopant is yttrium oxide. The glass composition may comprise a single dopant or any suitable combination of two or more different dopants.

The total dopant concentration can be selected as desired for a particular purpose, use, or to provide an article with particular properties. As described above, the dopant can be selected to affect the transmittance of the final article, or to provide an article that exhibits low leaching. Dopants can be selected such that they reduce the working point temperature of the glass and its viscosity at a particular temperature and also such that the final glass product will exhibit low extractables and/or leaching of ions into drugs, aqueous drug formulations, or other compositions that come into contact therewith. In one embodiment, the dopants are to be added in an amount to reduce the working point temperature of the resultant quartz composition to less than 1,650° C.

In one embodiment, the dopant is present in an amount of from about 0.0001 to about 18% by weight of the total composition. In another embodiment, the total amount of dopants is in the range of about 0.01 to about 8 wt. %. In still another embodiment, the total amount of dopant ranges from about 0.1 to about 8 wt. %. In another embodiment, the dopant is present in an amount of from about 0.5 to about 5% by weight of the glass composition. It will be appreciated that some dopants can be added in an amount as low as about 0.01 wt. %, and may be, for example, in a range of from about 0.01 to about 0.1 wt. % including, for example, from about 0.01 to about 0.05 wt. %. Here as elsewhere in the specification and claims, numerical values can be combined to form new and non-disclosed ranges.

The glass compositions, in one embodiment, contain a low concentration of metal impurities. The impurities may comprise metals other than the dopant metals. In one embodiment, the metal impurities include metals other than Al, Ge, Ga, Ce, Zr, Ti, Y, La, Nd, or other rare earth metals. In one embodiment, the total concentration of metal impurities is less than 1.0 wt. % or less. In another embodiment, the total concentration of metal impurities is less than 0.5 wt. % or less. In still another embodiment, the total concentration of metal impurities is less than 0.015 wt. % or less. In one embodiment, the metal impurities include alkali metals. In one embodiment, the total alkali metal concentration is less than 1.0 wt. % or less. In another embodiment, the total alkali metal concentration is less than 0.5 wt. % or less. In still another embodiment, the total alkali metal concentration is less than 0.015 wt. % or less. In one embodiment, the glass composition comprises about 3 wt. % or less of B₂O₃; about 2 wt. % or less of B₂O₃; about 1 wt. % or less of B₂O₃; even about 0.1 wt. % or less of B₂O₃.

Non-limiting examples of suitable glass compositions for forming containers to house biological macromolecule-containing compositions, include those described in one or more of U.S. patent application Ser. Nos. 11/557,885; 13/391,527; 13/477,396, and PCT Application PCT/US2010/046189, the entire disclosures of which are incorporated herein by reference.

The containers can be formed by any suitable process or method to form glass articles. In one embodiment, a pharmaceutical packaging article comprising the glass composition is formed by thermal processing, such as flame fusion conversion process.

The glass products and containers formed from the glass compositions have a high UV transmittance, i.e., low absorbance over a wide range of wavelengths including in the LTV range. In one embodiment, the glass products for housing the protein-containing compositions are UV transmissible between 200 and 350 nm. In one embodiment, the container has a UV transmittance of from about 50% to about 94% at wavelengths of from about 200 nm to 300 nm. In one embodiment, the container has a UV transmittance of about 50% or greater at wavelengths of from about 200 nm to 300 nm. In one embodiment, the container has a UV transmittance of about 80% or greater at wavelengths of from about 200 nm to 300 nm. As used herein, the transmittance refers to the percent transmission though a 3 mm thick sample formed from the composition. The glass composition, including the dopant concentration can be selected to provide a glass composition having a high UV transmittance that can be used in a spectroscopic analytical method such as UV spectroscopy. Thus, in one embodiment, the glass composition is selected to provide a glass article that is UV transmissible between 200 and 350 nm. In still other embodiments, the glass article is transmissive to UV wavelengths, wavelengths in the visible region, and/or infrared radiation that is now suitable or may be suitable for analyzing and detecting the integrity of a therapeutic biological materials.

The containers can have any shape as desired for storing a protein-containing composition. The walls of the container can be substantially flat, curved, or a combination thereof. The container can have any regular, irregular, symmetric, or asymmetric polygonal shape. In one embodiment, the container can be in the form of a cylinder having a substantially circular perimeter. In one embodiment, at least a portion of two parallel walls of the container have a substantially flat or planar surface. In one embodiment, the containers can be in the form of vials, ampoules, syringes, bottles, etc.

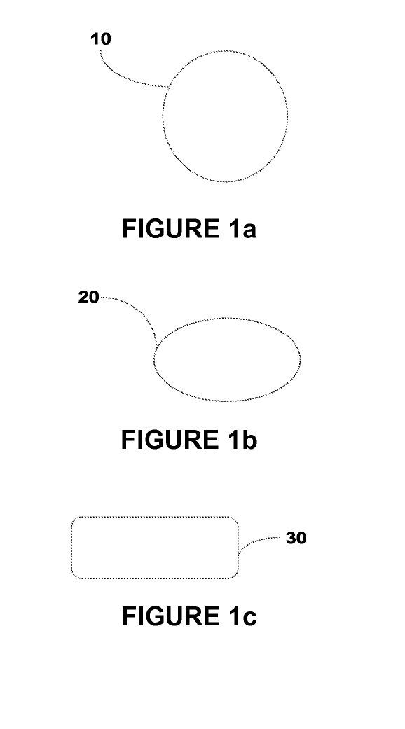

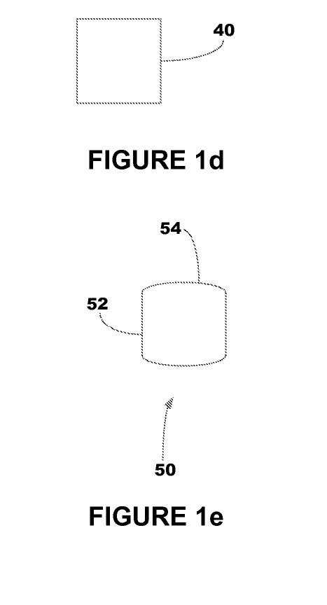

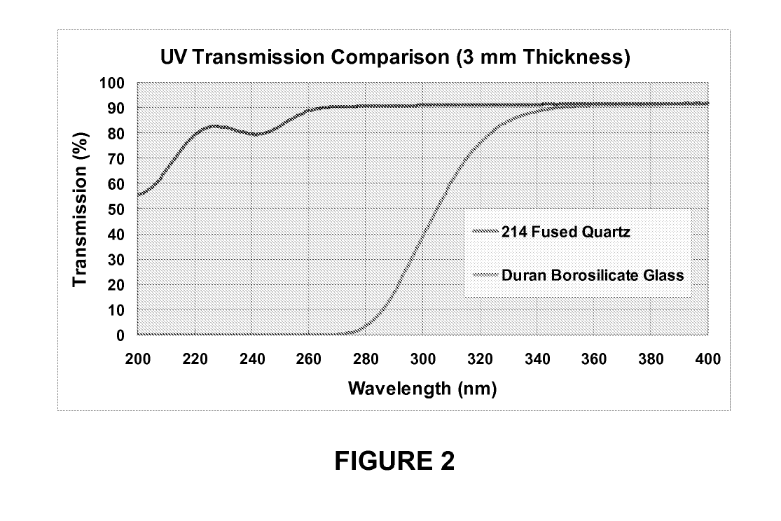

FIGS. 1a-e illustrate non-limiting examples of suitable perimeter shapes of the containers: in FIG. 1a, the container 10 has a circular perimeter (such as a cylinder or tube), container 20 has an elliptical perimeter (FIG. 1b); container 30 has a rectangular perimeter (FIG. 1c); and container 40 has a square perimeter (FIG. 1d). FIG. 1e illustrates a container 50 having a perimeter comprising generally opposing walls 52 substantially planar and disposed in parallel planes and opposing walls 54 having a slightly curved surface. It will be appreciated that polygonal shaped containers, e.g., rectangular or square configurations, can have rounded corners. It will be appreciated that other configurations and shapes are possible and not limited to those shapes described above.

As used herein, “biological macromolecule” refers to a chemical compound, either naturally occurring or synthetic, exhibiting an activity or functionality that renders it suitable as a therapeutic agent. A “therapeutic agent” refers to a substance exhibiting biological, physiological, or pharmacological activity that acts locally or systemically in a subject. Biological macromolecules can include, but are not limited to, a nucleic acid, an antibody, a protein, a peptide, DNA, RNA, a gene, etc. While aspects of the invention may described with respect to proteins, it will be appreciated that biological macromolecules are not limited to proteins.

The biological macromolecule-containing compositions are not limited and can be provided as desired for a particular use and application. Biological macromolecule-containing compositions generally comprise a biological macromolecule and a carrier material (which is also referred to herein as an excipient). The biological macromolecule-containing compositions are not particularly limited and include any biological macromolecule that is amenable to analysis using analytical techniques, such as, but not limited to, UV spectroscopy, for evaluating a property of the biological macromolecule that relates to the structure, structural integrity (or degradation), concentration, or other property of the biological macromolecule that can relate to the quality of the composition as a therapeutic agent.

In one embodiment, the biological macromolecule comprises a protein. The proteins in the biological macromolecule-containing compositions are not limited. The proteins can be obtained from any suitable source or method including, but not limited to, purified proteins obtained from a natural source, synthetic proteins, or proteins obtained via recombinant techniques. The proteins can be naturally occurring proteins, derivatives thereof, or synthetic proteins.

Examples of suitable proteins include, but are not limited to, glycoproteins, lyoproteins, lipoproteins, phosphoproteins, sulphoproteins, iodoproteins, methylated proteins; proteins can be modified or unmodified proteins, etc. The protein component can be any protein, including, for example, therapeutic proteins; prophylactic proteins, including antibodies; cleaning agent proteins, including detergent proteins; personal care proteins, including cosmetic proteins; veterinary proteins, food proteins, feed proteins, diagnostic proteins, decontamination proteins, etc.

The proteins can be modified proteins including, for example, fragments, muteins, conjugated proteins, fusion proteins, etc. Protein fragments, which can include peptides of proteins, can be produced, by any means, including proteolytically, by recombinant DNA technology, or naturally.

Mutein proteins can be mutants of naturally occurring proteins, produced, for example, by recombinant DNA technology.

Conjugated proteins can be conjugated with a small chemical, a toxin, a radioactive isotope, or any other compound that can be conjugated to a protein.

Fusion proteins comprise two or more proteins, or fragments thereof.

In one embodiment, the proteins can be enzymes, such as, for example, hydrolases, isomerases, lyases, ligases, adenylate cyclases, transferases oxidoreductases, etc. Examples of hydrolases include, but are not limited to, elastase, esterase, lipase, nitrilase, amylase, pectinase, hydantoinase, asparaginase, urease, subtilisin, thermolysin, other proteases, lysozyme, etc. Non-limiting examples of lyases include aldolases and hydroxynitrile lyase. Non-limiting examples of oxidordutases include peroxidase, laccase, glucose oxidase, alcohol dehydrogenase and other dehydrogenases. Other examples of enzymes include cullulases and oxidases.

Examples of therapeutic or prophylactic protein include, but are not limited to, hormones such as insulin, glucogonlike peptide 1 and parathyroid hormone, antibodies, inhibitors, growth factors, postridical hormones, nerve growth hormones, blood clotting factors, adhesion molecules, bone morphongenic proteins and lectins trophic factors, cytokines such as TGF-β, IL-2, IL-4, α-IFN, β-IFN, γ-IFN, TNF, IL-6, IL-8, lymphotoxin, IL-5, Migration inhibition factor, GMCSF, IL-7, IL-3, monocyte-macrophage colony stimulating factors, multidrug resistance proteins, other lymphokines, toxoids, erythropoietin, Factor VIII, amylin, TPA, dornase-α, α-1-antitrypsin, human growth hormones, nerve growth hormones, bone morphogenic proteins, urease, toxoids, fertility hormones, FSH and LSH.

Non-limiting examples of therapeutic proteins include leukocyte markers, histocompatibility antigens, integrins, adhesion molecules, selectins, interleukins, interleukin receptors, chemokines, growth factors, growth factor receptors, interferon receptors, Igs and their receptors, and blood factors.

The carrier or excipient in the protein-containing composition is not limited and can be chosen for a particular purpose or intended use. Examples of suitable carriers include, but are not limited to amino acids, surfactants, sugars, bulking agents and antimicrobials.

Specific examples of suitable carriers include but are not limited to, salts of amino acids such as glycine, arginine, aspartic acid, glutamic acid, lysine, asparagine, glutamine, proline; carbohydrates, e.g., monsaccharides such as glucose, fructose, galactose, mannose, arabinose, xylose, ribose, disaccharides, such as lactose, trehalose, maltose, sucrose; polysaccharides, such as matodextrins, dextrans, starch, glycogen; alditols, such as mannitol, xylitol, lactitol, sorbitol; glucuronic acid; galacturonic acid; cyclodextrins, such as methyl cyclodextrin, hydroxypropyl-β-cyclodextrin, etc.; inorganic salts, such as sodium chloride, potassium chloride, magnesium chloride, phosphates of sodium and potassium, boric acid ammonium carbonate and ammonium phosphate; organic salts, such as acetates, citrate, ascorbate, lactate; emulsifying or solubilizing agents like acacia, diethanolamine, glyceryl monostearate, lecithin, monoethanolamine, glyceryl monostearate, lecithin, monoethanolamine, oleic acid, oleyl alcohol, poloxamer, polysorbates, sodium lauryl sulfate, stearic acid, sorbitan monolaurate, sorbitan monostearate, and other sorbitan derivatives; polyoxyl derivatives, wax, polyoxyethylene derivatives, sorbitan derivatives; and viscosity increasing reagents such as, agar, alginic acid and its salts, guar gum, pectin, polyvinyl alcohol, polyethylene oxide, cellulose and its derivatives propylene carbonate, polyethylene glycol, hexylene glycol, tyloxapol. In still another embodiment, the carrier or excipient can be chosen from a silicon-containing material. Examples of suitable silicone-containing materials include those available from Momentive Performance Materials.

The concentration of the biological macromolecule in the biological macromolecule-containing composition is not limited and can be chose for an intended purpose or application. In one embodiment, the biological macromolecule concentration is provided at a selected concentration for application in a therapeutic or medicinal treatment protocol such that the biological macromolecule-containing composition can be used directly in a treatment protocol without the need to be further diluted or adjusted prior to use.

In one embodiment, a method for analyzing the state of a biological macromolecule-containing composition comprises: (a) providing a biological macromolecule-containing composition disposed within a container for storing the composition prior to use of the composition; (b) subjecting the container to an analytical technique; and (c) determining a property of the biological macromolecule-containing composition corresponding to a property of the biological macromolecule. Properties of the biological molecule, composition can be indicative of the concentration of the biological macromolecule, the primary, secondary, tertiary, or quartenary structure of the molecule, a change in the affinity of the macromolecule to bind to another agent, post translational modification of the molecule, the enzymatic activity of the molecule, denaturation, aggregation, etc. Such changes can affect the efficiency of the composition as a therapeutic agent. Changes in structure of configuration, e.g., degredation can potentially alter or destroy the macromolecules ability to function as a therapeutic agent.

In one embodiment, the method comprises direct measurement of the absorbance or transmittance of the biological macromolecule-containing composition in the container without the need to open the container or remove any portion of the biological macromolecule-containing composition from the container. The high transmittance containers can be formed from glass compositions described herein.

In one embodiment, the method comprises the direct evaluation of a biological macromolecule-containing composition in the container or package in which it is contained without the need for transferring the biological macromolecule-containing composition to another vessel such as a cuvette. The present system and method also provide a non-destructive, process to analyze biological macromolecule-containing compositions in their containers or packaging. The containers or packages containing the biological macromolecule-containing composition are transmissible to certain wavelengths and can be directly used in an analytical technique such as UV spectroscopy to analyze a composition to evaluate the structural integrity or concentration of the protein and whether degradation has occurred.

Suitable analytical techniques for evaluating the compositions include spectroscopic methods such as UV spectroscopy, circular dichorism, etc. UV absorption spectroscopy is one of the most significant methods to determine protein properties. It can provide information about protein concentrations and the immediate environments of chromophoric groups. Protein functional groups, such as amino, alcoholic (or phenolic) hydroxyl, carbonyl, carboxyl, or thiol can be transformed into strong chromophores. Visible and near UV spectroscopy can be used to monitor two types of chromophores: metalloproteins (more than 400 nm) and proteins that contains Phe, Trp, Tyr residues (260-280 nm). The change in UV or fluorescence signal can be negative or positive, depending on the protein sequence and solution properties.

Generally, the concentration and condition of a biological macromolecule-containing composition can be determine using the Beer-Lambert law: A=∈×b×C, where A is the absorbance in the unit of optical density (OD), ∈ is the extinction coefficient of the proteins or nucleic acids at a particular wavelength in M⁻¹cm⁻¹, b is the optical path length through the sample in cm, and C is the sample concentration. It will be appreciated that the transmittance of the sample can also be used to evaluate the protein concentration or degradation as transmittance is related to absorbance as A=log T, where A is the absorbance and T is the transmittance of the solution. Any suitable method or technique for evaluating transmittance can be used to determine the transmittance of the sample.

Circular dichroism (“CD”) can be used to detect any asymmetrical structures, such as proteins. Optically active chromophores absorb different amount of right and left polarized light, this absorbance difference results in either a positive or negative absorption spectrum (usually, the right polarized spectrum is subtracted from the left polarized spectrum). Commonly, the far UV or amide region (190-250 nm) is mainly contributed from peptide bonds, providing information on the environment of the carbonyl group of the amide bond and consequently the secondary structure of the protein alpha-helix usually displays two negative peaks at 208, 222 nm (Holzwarth et al. J Am Chem Soc 178:350, 1965), beta-sheets display one negative peak at 218 nm, and random coils have a negative peak at 196 nm. Near UV region peaks (250-350 nm) are contributed from the environment of the aromatic chromophores (Phe, Tyr, Trp). Disulfide bonds give rise to minor CD bands around 250 nm.

Intense dichroism is commonly associated with the side-chain structures being held tightly in a highly folded, three-dimensional structure. Denaturation of the protein mostly releases the steric hindrance, and a weaker CD spectrum is obtained along with an increasing degree of denaturation. For example, the side chain CD spectrum of hGH is quite sensitive to the partial denaturation by adding denaturants. Some reversible chemical alterations of the molecules, such as reduction of the disulfide bonds, or alkaline titrations will change the side-chain CD spectrum. For hGH, for example, these spectral difference can be caused by the removal of a chromophore, or by affecting changes in the particular chromophore's CD response, but not by the gross denaturation or conformational changes (Aloj et al. J Biol Chem 247:1146-1151, 1971).

Still other methods can be used to analyze a property of the biological molecule that is indicatie of the integrity of the composition include, but are not limited to, IR spectroscopy, Raman spectroscopy, ultrasonic spectroscopy, etc.

The containers can be provided in any suitable shape or form as desired for a particular purpose or intended use. In one embodiment, the containers are in the form of vials, ampules, syringes, bottles, etc. The dimensions of the container, including the length, width, diameter, wall thickness, etc., are not limited and can be selected as desired for a particular purpose or intended use. The containers can have a shape suitable for a particular use where such shape is also suitable for insertion into an apparatus, e.g., a spectrometer, for evaluating denaturation of the protein. As previously described, in one embodiment, the containers may comprise parallel walls having substantially planar surfaces.

The parameters to be evaluated can be chosen by those skilled in the art. The absorbance of the biological macromolecule-containing solution can be measured directly or by measuring the transmittance of the solution. The absorbance or transmittance of a blank sample is subtracted from the sample absorbance readings. The optical path length of the container is used to calculate the concentration of the sample at a particular wavelength.

In one embodiment, an apparatus, such as a UV spectrometer, is provided and configured to receive containers of differing shapes and sizes. The light source can be any suitable source for use in LTV spectroscopy. Common UV lamp sources are Deuterium lamp and Xenon lamp, which cover the entire 200 nm-350 nm ranges. Tungsten lamp, light emission diodes (LED), and diode lasers are visible light sources.

Conventional LTV spectroscopy of protein-containing compositions is performed by pipetting several milliliters (ml) of biological samples into a square cuvette, positioning the cuvette into a holder in a spectrometer, and scanning the spectrum over the whole spectral range of interest. This method is precise and accurate, but it consumes a large volume of sample and the sample can be contaminated easily due to the transportation between the sampling tubes and cuvettes. Moreover, the process is labor intensive and time consuming, especially when hundreds of samples need to be measured. The present invention allows for the in-line inspection of protein-containing compositions to determine whether the protein has undergone denaturation. By providing a biological macromolecule-containing composition in a container that can be used in an analytical technique to evaluate protein denaturation, quality control and quality standards can be improved. In one embodiment, 100% of the compositions in a lot or group of packaged materials can be evaluated as there is no concern that any samples or containers need to be destroyed or the compositions subjected to environmental conditions that could contaminate the sample such that it will have to be discarded. The system and method also allow for on-site analysis of samples such as at medical facilities or other locations where the biological macromolecule-containing composition is going to be administered.

Conventional packages and containers for biological macromolecule-containing compositions such as pharmaceutical compositions are often formed from Type I or Type II glasses. Type I glass is a borosilicate glass, and Type II glass is a sodium-calcium based glass. Type I and Type II glasses are impervious to radiation in the LTV range and cannot be used to analyze protein denaturation of protein-containing compositions disposed within containers made of such glasses. As shown in FIG. 1, a fused glass composition such as type 214 quartz (having a SiO₂ content of around 99.998 wt. %) and available from Momentive Performance Materials has a high LTV transmittance in the LTV and particularly in the range of 200 nm to 300 nm as compared to Duran borosilicate glass, which is of a type conventionally used for pharmaceutical containers. Thus, analysis of compositions provided in containers formed from the conventional borosilicate glass requires opening or unsealing the container and extracting a sample from the container for analysis. This can result in destruction of the container and potential contamination of the protein-containing composition.

The foregoing description identifies various, non-limiting embodiments of glass compositions and articles made therefrom in accordance with aspects of the present invention. Modifications may occur to those skilled in the art and to those who may make and use the invention. The disclosed embodiments are merely for illustrative purposes and not intended to limit the scope of the invention or the subject matter set forth in the following claims.

What is claimed is:

1. A method for the direct analysis of a therapeutic composition comprising a biological macromolecule for a property relating to the therapeutic quality of the composition, the method:
providing a biological macromolecule composition disposed within a container from which the biological macromolecule-containing composition is to be dispensed for use in a treatment protocol;
subjecting the container comprising the biological macromolecule-containing composition to an analytical technique and determining a property of the composition corresponding to a property of the biological macromolecule of the composition.

2. The method of claim 1, wherein the analytical technique is chosen from UV spectroscopy, circular dichroism, IR spectroscopy, Raman spectroscopy, or a combination of two or more thereof.

3. The method of claim 1 comprising determining the transmittance, absorbance, or both the transmittance and absorbance of the biological macromolecule-containing composition.

4. The method of claim 1, wherein the container comprising the biological macromolecule-containing composition is formed from a quartz glass composition having a SiO₂ concentration of about 82% to about 99.999% or greater.

5. The method of claim 1, wherein the container comprising the biological macromolecule-containing composition is formed from a quartz glass composition having a SiO₂ concentration of about 92% to about 99.9999% or greater.

6. The method of claim 1, wherein the container comprising the biological macromolecule-containing composition is formed from a quartz glass composition having a SiO₂ concentration of about 99.9% or greater.

7. The method of claim 1, wherein the container comprising the biological macromolecule-containing composition is formed from a quartz glass composition having a SiO₂ concentration of about 99.99% or greater.

8. The method of claim 1, wherein the container comprising the biological macromolecule-containing composition is formed from a quartz glass composition having a SiO₂ concentration of about 99.999% or greater.

9. The method of claim 1, wherein the container is UV light transmissible at a range of about 200 nm to about 350 nm.

10. The method of claim 1, wherein the container is formed from a composition having a transmittance of at least 50% at a range of from about 200 nm to about 300 nm at a wall thickness of 3 mm.

11. The method of claim 1, wherein the container is formed from a composition having a transmittance of at least 80% at a range of from about 250 nm to about 300 nm at a wall thickness of 3 mm.

12. The method of claim 1 comprising providing a lot of biological macromolecule-containing compositions, and subjecting each composition in the lot to the analytical technique.

13. The method of claim 1, wherein the container has a circular perimeter.

14. The method of claim 1, wherein the container comprises at least a pair of parallel side walls having a substantially planar surface.

15. The method of claim 1, wherein the container is chosen from a vial, an ampoule, or a syringe.
